(19) United States
(12) Patent Application Publication
(10) Pub. No.: US 2009/0314697 A1
(43) Pub. Date: Dec. 24, 2009

(54) Liquid Filter With A Non-Return Valve In The Filtered Side Flow Channel

(75) Inventor: Wilhelm Ardes, Ascheberg (DE)

Correspondence Address: BOHAN MATHERS, PO BOX 17707, PORTLAND, ME, 04112-8707, US

(73) Assignee: HENGST GMBH & CO. KG, Muenster (DE)

(21) Appl. No.: 12/299,826

(22) PCT Filed: May 10, 2007
(86) PCT No.: PCT/DE07/00869

§ 371 Date: Jun. 1, 2009

(30) Foreign Application Priority Data
May 10, 2006 (DE) 20 2006 007 560.7
May 4, 2007 (DE) 20 2007 006 385.7

(51) Int. Cl. B01D 35/153

(52) U.S. Cl. 210/136

(57) ABSTRACT

Disclosed is a liquid filter for an internal combustion engine. The filter has a housing, a removable cover for closing the housing, and a replaceable filter insert that has a filter surface through which liquid can flow. The filter surface defines a boundary between a flow channel on the filtered side and a flow channel on the unfiltered side of the filter. A non-return valve allows the liquid to flow through the filter at pressure conditions that prevail when the engine is running. When the engine is shut off, the non-return valve prevents flow of liquid through the filter, thereby holding within the filter housing the liquid that was in the filter when the engine was shut off. The non-return valve is placed in the flow channel on the filtered side.

### BACKGROUND INFORMATION

1. Field of the Invention

The invention relates to a liquid filter for use in an internal combustion engine.

2. Description of the Prior Art

Liquid filters are known in the industry as oil filters. Such filters may also serve as fuel filters or as coolant filters in the field of internal combustion engines. The respective liquid is customarily pumped in a closed circuit loop by means of an oil, fuel, or water pump. When the internal combustion engine is not running, the respective liquid pump is also customarily shut down. This is particularly the case, when the pump is mechanically driven by the internal combustion engine. The non-return valve ensures that when the liquid pump is shut down, the liquid does not flow out of the filter housing, for example, as a result of gravitational force, and, in the case of an oil filter, flow back into the crankcase of the internal combustion engine. Rather, the liquid is retained in the filter housing, even when the internal combustion engine is shut off, so that when the engine is restarted, the flow channels conducting the liquid are filled as quickly as possible, without the liquid pump first having to fill the volume within the filter. This prevents, or limits to the shortest possible duration, a dry run of the lubricating points, if, for example, the circuit is for lubrication.

The volume of liquid on the unfiltered side of the filter is high, compared with the volume of liquid on the filtered side. For this reason, the non-return valve is provided on the unfiltered side of the filter, so that when the internal combustion engine or the liquid pump is not running, i.e., when the non-return valve is in its closed position, it reliably retains the unfiltered liquid in the filter.

The task of the invention is to improve upon a generic liquid filter, such that the filter can be mounted as simply as possible and also to achieve problem-free placement of a non-return valve on the liquid filter, even under spatially limited dimensions and when the dimensions of the filter are correspondingly small.

### BRIEF SUMMARY OF THE INVENTION

This task is fulfilled by providing a liquid filter that has a non-return valve mounted in the flow channel on the filtered side of the liquid filter.

The invention proposes, in other words, that the non-return valve not be arranged on the unfiltered side of the filter, that is, there, where the return flow of liquid is to be prevented, but rather, surprisingly, that the non-return valve be arranged in the flow channel on the filtered side. This innovation derives from the notion that the non-return valve enables such a tight seal of the filtered-side flow channel that it prevents pressure compensation with the interior of the filter, i.e., for example, via ventilation. Such pressure compensation, however, would be necessary for the liquid to flow out of the interior of the filter, for example, in the case of an oil filter, to flow back into the crankcase of the internal combustion engine.

Placing or arranging the non-return valve in the filtered-side flow channel has several advantages: On the one hand, when the filter construction includes a central filtered-oil outlet, the non-return valve can be provided without a problem in this centrally arranged filtered-oil outlet, so that basically the accessibility of this assembly site is simpler and less problematic than an assembly site having a laterally positioned flow channel. This is particularly true for especially small-sized filters, the diameters of which are subject to severely limited engineering requirements. For such filters, this may possibly be the only way possible to realize a non-return valve, because, according to the proposal, the non-return valve can be placed in the central axis of the filter.

The axial direction of the filter normally has sufficient space, even under cramped installation conditions, because for maintenance purposes alone, access to the lid of the filter housing must be provided in this axial direction. Also, in any event, it is intended that the lid and the filter insert be removed during regular maintenance work. Thus, access to the filter in the axial direction is not critical space-wise. The non-return valve may be placed here without a problem, even if, because of this, the height of the filter must be increased slightly in the axial direction. In the radial direction, on the other hand, the arrangement of additional components can be significantly more complicated or even impossible.

The unfiltered-side flow channel may connect geodetically higher to the housing than the filtered-side flow channel. Nevertheless, an appropriately tightly sealing non-return valve, even though arranged lower than the unfiltered-side flow channel, will still prevent the aforementioned pressure compensation, thus ensuring that the liquid does not flow out of the filter.

Furthermore, placing the non-return valve on the filtered side of the filter gives the engineer considerably more engineering freedom when developing the filter. For example, it is possible and relatively simple to place the non-return valve in a pre-assembled unit, which may then be inserted into a component that is prefabricated by the vehicle or motor manufacturer, such as a filter retainer or base. This eliminates the need to provide a housing for the filter, which requires assembly sites for mounting it, for example, on a crankcase of the internal combustion engine. Instead, the filter base can be molded in a space-saving manner into the crankcase. In such a case, however, accessibility to radial flow channels in the filter base is complicated, so that arranging the non-return valve there would be impossible or at least very difficult. Furthermore, for such an application, the non-return valve would have to be assembled by the vehicle or motor manufacturer. According to the inventive proposal, on the other hand, even when spatial conditions are so tight that they would make an off-center or radial arrangement of the non-return valve impossible, a non-return valve can easily be arranged in the area of the filter base.

The proposed embodiment of the liquid filter makes it possible to implement even those filters with especially small structural dimensions, for example, a filter plus the non-return valve that has a diameter that is clearly less than 80 mm, in other words, a filter with a housing diameter of approx. 60 mm.

The non-return valve can, for example, be advantageously provided inside the filter insert, because space for installing the filter insert must be provided in any event. An inner drain line is provided for the filtered liquid in the case of radial flow through the filter insert from outside to the inside. For this flow-through direction, a so-called inner dome is already provided in the filter insert, that is, a stiffening element that prevents the filter surface from collapsing under the pressure and temperature conditions that prevail during operation. Thus, this inner dome can, for example, also support the non-return valve.

Within the context of the present proposal, a distinction is made between the previously described inner dome and a so-called support dome, which can be provided as an alternative to the inner dome as a support element for the filter surface. This support dome differs from the aforementioned inner dome in that it is not part of the filter insert, so that when a filter is replaced, the number of elements and amount of material that must be exchanged are kept to a minimum, which is both ecologically and economically advantageous.

If a support dome is provided, this support dome can advantageously support the non-return valve. The support dome can, for example, be affixed to the housing of the filter and, if necessary, be detachably affixed to the housing by means of screws, clips, or similar means.

Alternatively, the support dome can be provided on the cover of the filter, and, regardless of whether the support dome is provided on the cover or the housing of the filter, a detachable fastener or bracket for the support dome can be provided on the housing or the cover, or the support dome can be constructed or molded as an integral component of the cover or housing, that is, from the same material.

### BRIEF DESCRIPTION OF THE DRAWINGS

Embodiments of the invention are described below in more detail using the drawings. In the drawings, the same or comparable components are designated by the same reference numerals, even if the components are constructed differently in different embodiments.

FIG. 1 illustrates a first embodiment of the filter according to the invention.

FIG. 2 illustrates the filter of FIG. 1, inserted into the base.

FIG. 3 illustrates the position of the filter, when the engine is running.

FIG. 4 illustrates the position of the filter during maintenance work.

FIG. 5 is a further illustration of the filter during maintenance work.

FIG. 6 illustrates a support dome and a filter bypass valve.

FIG. 7 illustrates the support dome affixed to the cover.

FIG. 8 illustrates the filtered-oil tube formed as part of the housing.

FIG. 9 is a further illustration of the filtered-oil tube of FIG. 8.

### DETAILED DESCRIPTION OF THE INVENTION

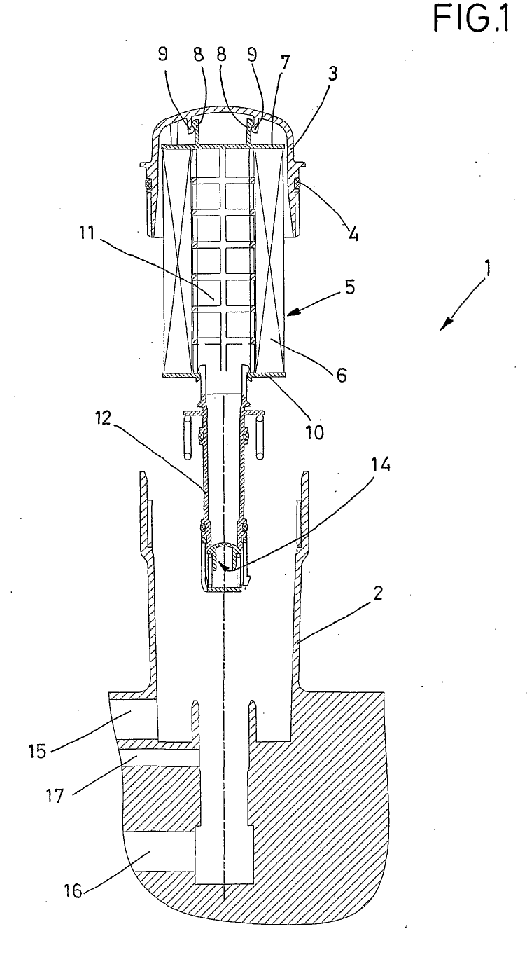

FIGS. 1-5 illustrate an embodiment of the filter 1 according to the invention. Reference designation 1 always designates the entire liquid filter, which, in the embodiment shown, is constructed as an oil filter. The oil filter 1 has a housing 2 that can be closed by a cover 3, whereby the cover 3 is screwed to the housing 2 in a known manner. A seal between housing 2 and cover 3 is provided by a circular gasket 4.

The filter insert 5 has a filter surface 6 in the form of a pleated-paper filter element, as well as an upper end plate 7 with a releasable connection 8, such as snap-in hooks or pawls, which cooperate with a corresponding releasable connection 9 on the cover side 9, so that the filter insert 5 is detachably fastened to the cover 3 by means of this snap-in or clip connection 8/9.

The filter insert 5 also has a lower end plate 10 and an inner dome 11 in the interior that is surrounded by the filter surface 6.

A conduit, for example, a filtered-oil tube 12, which has a non-return valve 14 on its lower end, is snapped together with the lower end plate 10 of the filter insert 5. The function of the filtered-oil tube 12 is discussed below in greater-detail.

The housing 2 is formed as part of a larger base or support component 2A. This base component 2A contains an inlet channel 15 for unfiltered oil, an outlet channel 16 for filtered oil, as well as a drain channel 17 for draining the housing 2 during maintenance work. A flowpath through the filter insert 5 includes an unfiltered-side flow channel 15A and a filtered side flow channel 16A, the liquid-permeable filter surface 6 defining a boundary between the filtered-side flow channel 15A and the unfiltered side flow channel 16A.

FIG. 1 shows the filter 1 suspended above the housing 2. The functional elements of the filter 1, such as the filter insert 5, various gaskets and valves, along with the cover 3; form a filter assembly or unit, with all of the components coupled together, so that this entire assembly can be handled as a single unit and inserted into the housing 2. The housing 2 can therefore be produced by an internal combustion engine manufacturer as part of a larger base module. The engine manufacturer does not have to assemble functional elements of the filter into the base, i.e., does not have to complete the functional capability of the filter 1. Rather, the complete filter unit can be delivered by the filter manufacturer and inserted as a unit into the base.

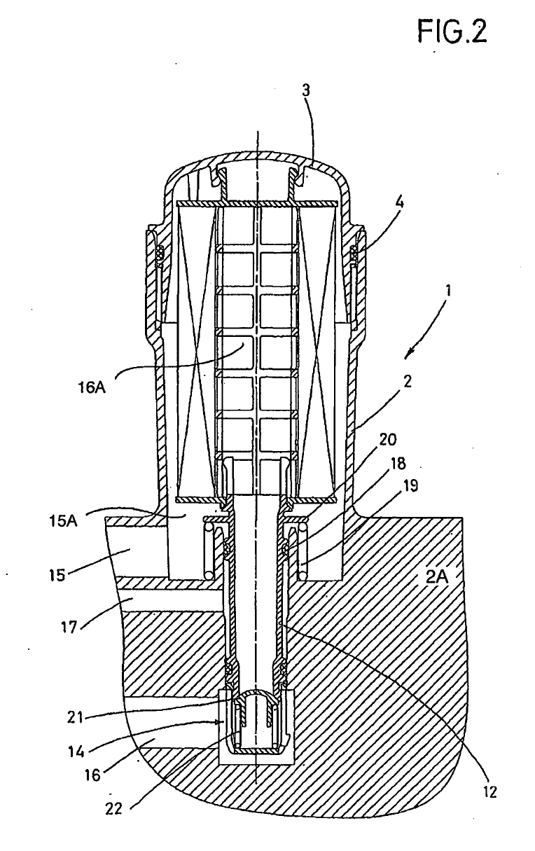

FIG. 2 shows the filter 1 in the assembled state, that is, inserted into the base 2A, when the internal combustion engine is off. The gasket 4 seals the cover 3 to the housing 2, and a gasket 18 prevents flow of liquid from the inside of the filter 1 along the filtered-oil tube 12 into the drain 17. A spring 19 that presses against the housing 2 or the base 2A, on the one hand, and against a surrounding flange 20 of the filtered-oil tube 12, on the other hand, is compressed in this installed state. The non-return valve 14 is closed. For this, a movable valve body 21 seats tightly against the lower opening of the filtered-oil tube 12, the valve body 21 being pressed against the filtered-oil tube 12 by a spring 22. Oil flows through the filter 1 while the internal combustion engine is running. When the internal combustion engine is shut off, the gasket 18 prevents oil from flowing out of the filter interior into the drain 17. At the same time, the non-return valve 14 is closed and, thus, prevents filtered oil, which is found radially inside the filter surface 6 within the inner dome 11 or in the filtered-oil tube 12, from flowing out of the filter 1. Furthermore, unfiltered oil present in the folds of the filter surface 6 or radially outside the filter insert 5 is prevented from flowing out of the filter 1 through the inlet channel 15 because of the absence of pressure compensation inside the filter. Such pressure compensation does not exist because the non-return valve 14 seals tightly.

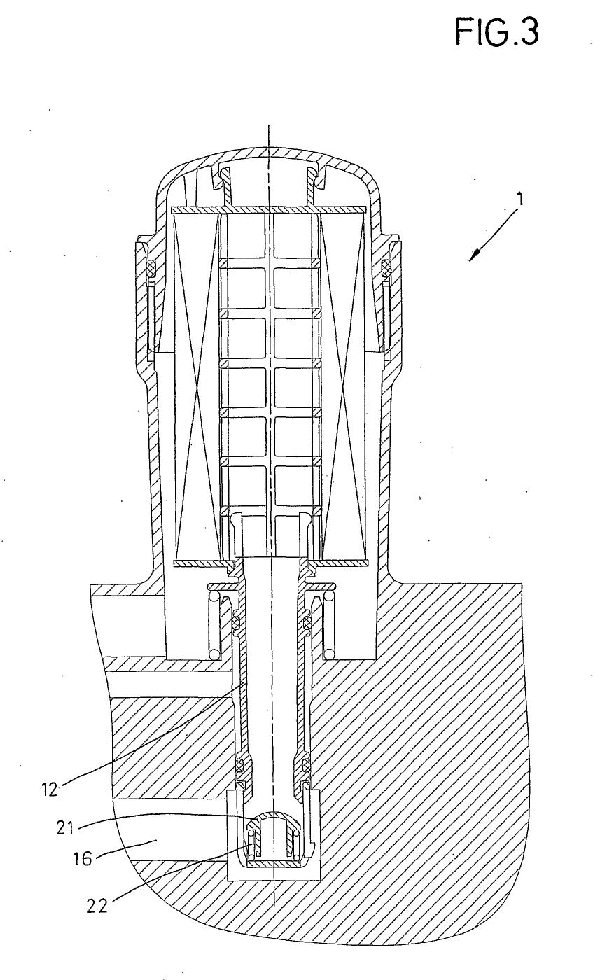

FIG. 3 illustrates the position of the filter 1 while the internal combustion engine is running. The basic configuration of the individual components is comparable to FIG. 2, except that the oil pressure has forced the non-return valve 14 open, i.e., the pressure forces the valve body 21 downward against the force of the spring 22, thereby opening a flow connection between the filtered-oil tube 12 and the outlet port 16.

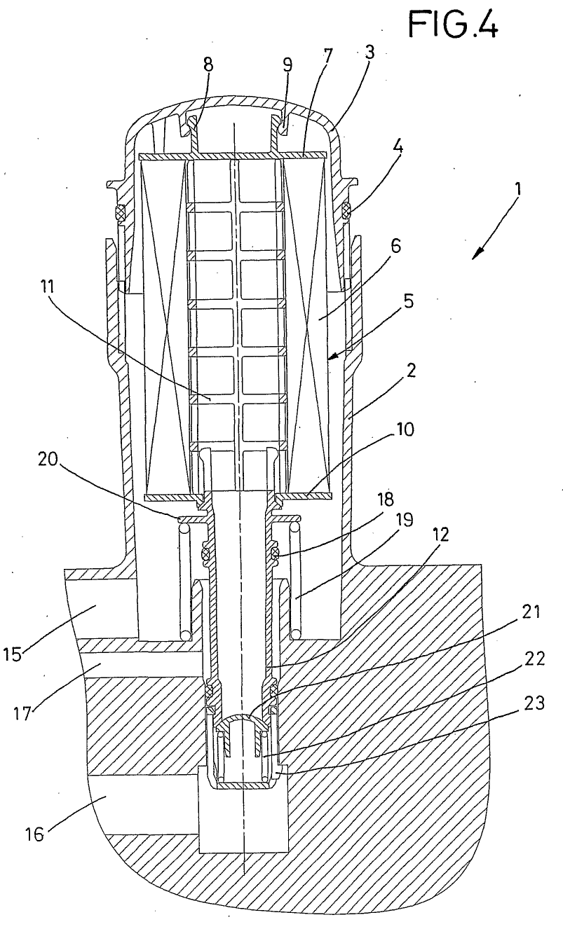

FIG. 4 shows the position of the filter 1 during maintenance work. The cover 3 is partially unscrewed from the housing 2. In other words, the screw threads on the cover 3 and the housing 2 are still engaged with each other, but the gasket 4 between the cover 3 and the housing 2 is no longer airtight, so that air can penetrate to the inside of the housing 2. Unscrewing the cover raises the filtered-oil tube 12 relative to its operating position, which is seen in FIGS. 2 and 3, into a maintenance position. In this maintenance position, several snap-in hooks or pawls 23 of the filtered-oil tube 12 stop against the edge of a recess or detente in the housing 2 or the base 2A, thus preventing an upwards movement of the filtered-oil tube 12 greater than the position shown in FIG. 4. The raised position of the filtered-oil tube 12 shown in FIG. 4 is supported by the spring 19, so that the filtered-oil tube 12 is held in its raised position. In this raised position, the gasket 18 no longer creates an airtight seal between the filtered-oil tube 12 and the housing 2, so that the oil located in the filter housing can now flow along the gasket 18 into the drain 17, thus enabling removal of the filter insert 5 from the filter 1 with the least possible drippage.

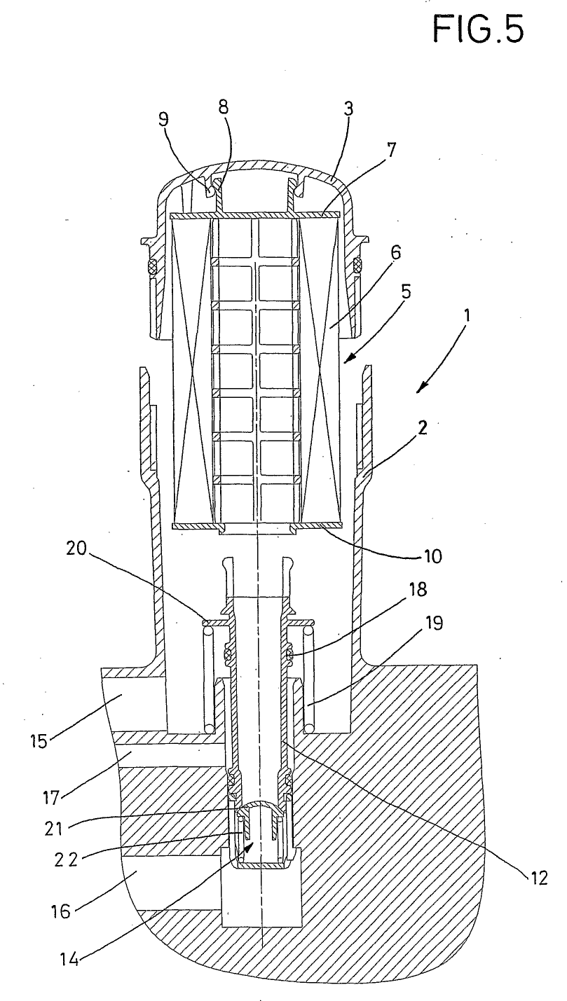

FIG. 5 shows further progression of the maintenance work. As previously described, the filtered-oil tube 12 is held in its raised position by the pawls 23 and the spring 19. Further upward movement of the cover 3 together with the filter insert 5 releases the snap-in connection between the filtered-oil tube 12 and the lower end plate 10 of the filter insert 5, so that the filtered-oil tube 12 remains in the housing 2 of the filter 1, while the filter insert 5, along with the cover 3, can be removed. The snap-in connection between the filtered-oil tube 12 and the lower end plate 10 is releasable with a relatively weak force. It serves a purpose only during initial assembly of the filter 1, to insert the functional assembly shown in FIG. 1 into the filter housing 2 and, thus, to combine all functional elements of the filter into a unit that can be handled as a single module. Compared to the catch or snap mechanism between the filtered-oil tube 12 and the lower end plate 10, the catch or snap mechanism between the upper end plate 7 and the cover 3 with the releasable connection 8 and 9, i.e., snap-pawls, is a significantly stronger construction, i.e., requires significantly more force to release it, so that the filter insert 5 remains reliably attached to the cover 3 when this cover 3 is removed from the housing 2. The cover 3 has a cone-shaped inner clearance toward its lower, open end, which expands radially toward the outside. This enables the maintenance person to force the filter insert 5 to tilt. Sufficient tilt will eventually overcome the snap or catch force of the releasable connection 8 and 9. In this manner the filter insert 5 can be released from the cover 3 by pressing the filter insert 5 diagonally against a surface, for example, against the wall of a trash can, while firmly holding the cover 3. This makes it possible to remove the filter insert 5 without having to handle the dirty filter insert 5 itself.

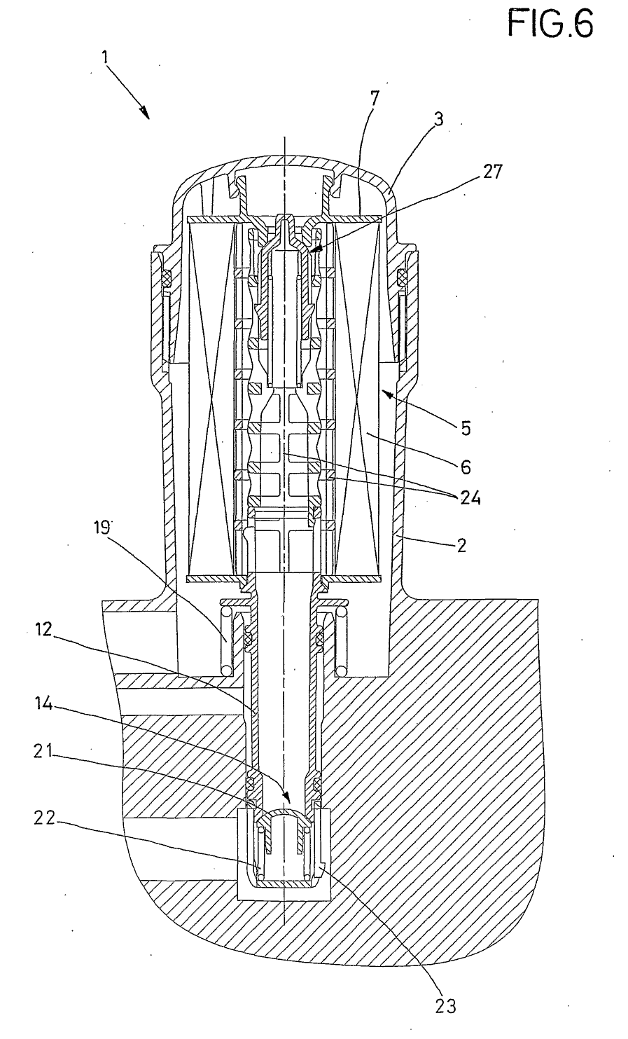

In the embodiments shown in FIGS. 1 to 5, the filter insert 5 shows the inner dome 11 as one of its components. As an alternative, a so-called support dome 24, separate from the customary filter insert 5, can be provided to support the filter surface 6, as is shown in FIGS. 6 to 9. The support dome 24 itself is a conventional component that is known in the industry in similar embodiments.

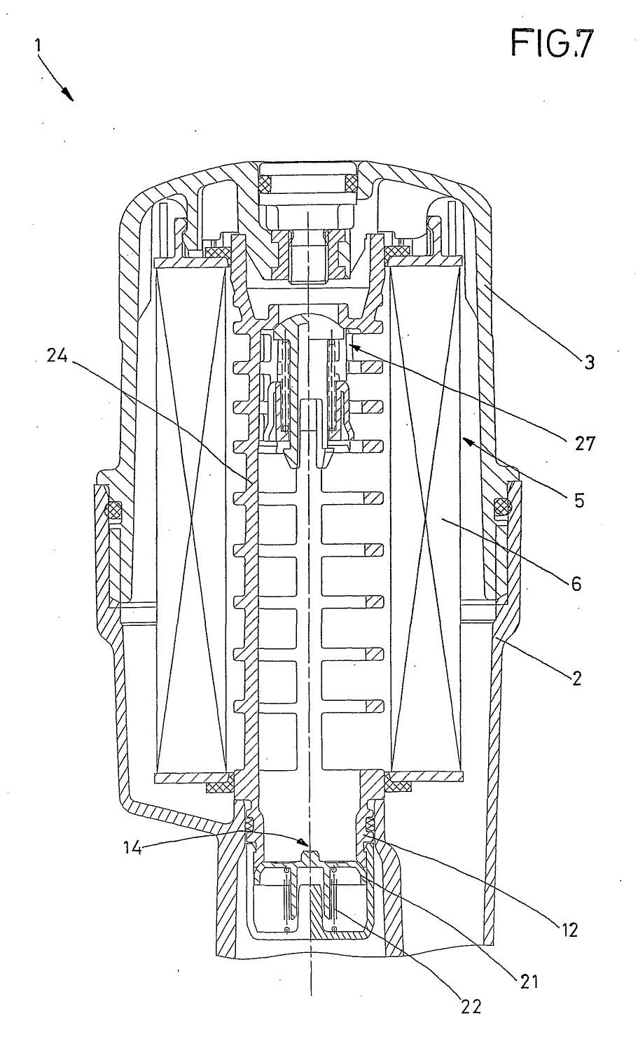

The construction of the support dome 24 can be such that, for example, as shown in FIGS. 6, 8, and 9, it is captively affixed to the housing 2 or, as shown in FIG. 7, to the cover 3.

FIG. 6 shows the support dome 24 captively restrained in the housing 2, using snap-in hooks or pawls 23, whereby the dome 24 is supported in the housing 2 and movable lengthwise. Furthermore, FIG. 6 shows a filter bypass valve 27 in the upper area of the support dome 24, whereby the movable valve body of the filter bypass valve 27 seats against a valve seat that is formed by the upper end plate 7 of the filter insert 5. The filter bypass valve 27 ensures a type of emergency supply of lubricating oil and opens when the amount of oil flowing through the filter surface 6 is insufficient, for example, when the oil is cold and viscous or when the filter surface 6 is very dirty.

FIG. 7 shows that the support dome 24 can be affixed to the cover 3 and thus movable relative to the housing 2, namely, so that it can also be removed when the cover 3 is removed.

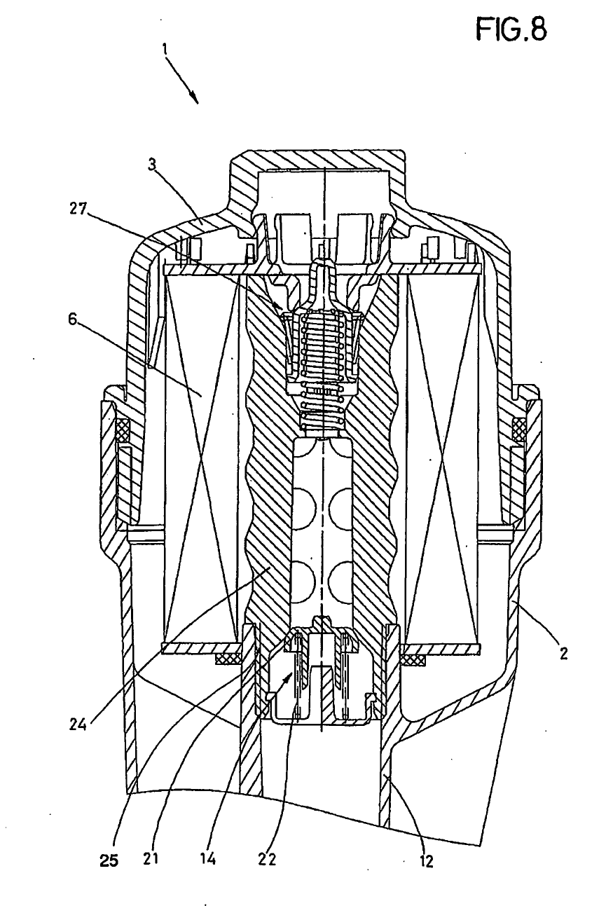

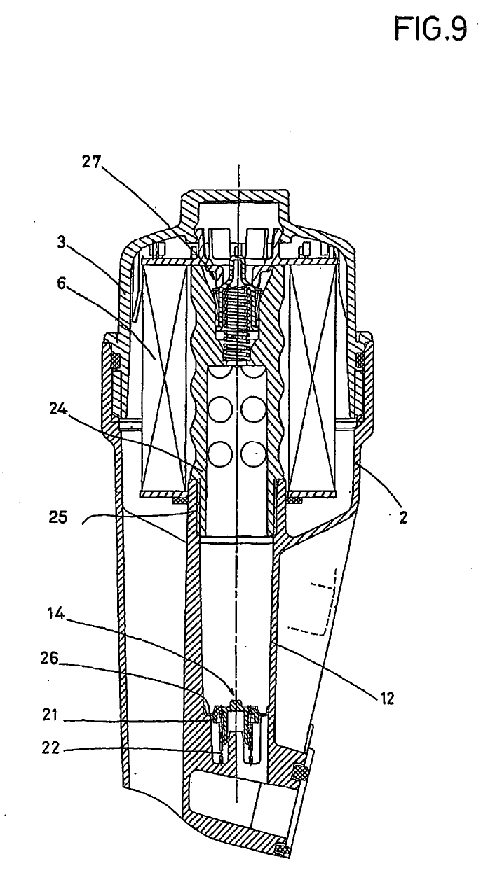

FIGS. 8 and 9 show that the support dome 24 can be affixed at a certain position in the housing 2 by screw fastening it with the housing 2 by means of a threaded connection 25.

A support dome 24 can be detachably affixed, for example, as in the embodiments shown in FIGS. 8 and 9, in which it can be unscrewed from the housing, or can be manufactured as an integral part, i.e., of the same material, as the other component, for example, the housing 2 or the cover 3.

The support dome 24 can, for example, be affixed to the housing 2 by connecting the support dome to the filtered-oil tube 12, similar to the means of affixing the filter insert 5 in FIGS. 1 to 5, or it can be constructed as a single component that forms the support dome and the filtered-oil tube.

FIGS. 8 and 9 show that the filtered-oil tube 12 does not have to be constructed as a separate component, but rather, can also be formed by the housing 2. In contrast to the other embodiments, FIG. 9 also shows that it is not necessary for the valve body 21 of the non-return valve 14 to be contained in a separate component, as with the other embodiments, but rather, that it can be supported on the housing 2 by means of the spring 22. In this case, a molded part 26 is pressed into the filtered-oil tube 12. The molded part 26 forms the valve seat, against which the valve body 21 is pressed by the pressure of the spring 22.

FIGS. 7 and 8 show that the non-return valve 14 is arranged considerably closer to the filter insert 5 than in the embodiments shown in FIGS. 1 to 6. As an additional alternative, not shown in the drawings, it is possible to position the non-return valve 14 even farther upwards and, thus, to place it inside the filter insert 5.

Furthermore, in deviation from the depicted embodiments, the construction can be such that the non-return valve 14 is not supported by a support dome attached to the filter housing 2, but rather, by a comparable so-called inner dome, which, however, is constructed as part of the filter insert 5 and which, like a support dome affixed to the housing, also serves to support the filter surface 6. For example, the relatively short support domes 24 shown in FIGS. 7 and 8 could be modified in such a way that they are constructed as an inner dome, that is, as part of the respective filter insert 5.

If necessary, the domes 24 could also be made even shorter than those shown in FIGS. 7 and 8, so as to realize the aforementioned alternative, to place the non-return valve 14 inside the filter insert 5, and thus, create a compact, replaceable unit.

In the embodiments shown, the support dome 24 is always shown as a separate component. In deviation from the shown embodiments, however, a support dome can be provided that is manufactured together with the housing, for example, in the form of a casting as a single component. Alternatively, the support dome—likewise deviating from the shown embodiments—can be manufactured together with the cover, as a single component.

1-17. (canceled)

18. Liquid filter for a combustion engine, the filter comprising:
a housing;
a removable cover that closes the housing;
a replaceable filter insert, which has a filter surface through which liquid flows;
a flowpath through the liquid filter that includes a flow channel on a filtered side of the filter and a flow channel on an unfiltered side, the two flow channels being separated from each other by the filter surface; and
a non-return valve disposed in the flow channel on the filtered side of the liquid filter, which enables flow through the liquid filter under the pressure conditions that exist during operation of the combustion engine;
wherein the non-return valve blocks the flowpath when the combustion engine is at standstill so as to hold within the housing the liquid that is in the housing when engine standstill commences.

19. Liquid filter of claim 18, wherein the unfiltered-side flow channel connects geodetically higher to the housing than the filtered-side flow channel.

20. Liquid filter of claim 18, further comprising:
a cover for covering the filter; and
a dome for supporting the filter insert;
wherein the cover, the filter insert, the dome, and the non-return valve are assembled together so as to form an assembly that is handleable as a single unit.

21. Liquid filter of claim 20, wherein the dome is an inner dome.

22. Liquid filter of claim 20, wherein the dome is a support dome.

23. Liquid filter of claim 20, wherein the functional components of the filter that include the filter insert, gaskets, valves, together with the cover are connected to each other so as to form the assembly that is handleable as the single unit.

24. Liquid filter of claim 18, wherein the non-return valve is arranged in a conduit that extends in the direction of the longitudinal axis of the filter.

25. Liquid filter of claim 18, wherein the housing has a maximum diameter of 80 mm.

26. Liquid filter of claim 18, wherein the non-return valve is arranged inside the filter insert.

27. Liquid filter of claim 21, wherein the non-return valve is supported by the inner dome.

28. Liquid filter of claim 22, wherein the support dome is fixedly attached to the housing and the non-return valve is supported by the support dome.

29. Liquid filter of claim 20, wherein the non-return valve is arranged in a flow channel that is formed in the housing.

30. Liquid filter of claim 20, wherein the non-return valve is arranged in a flow channel that is formed in a flange surface of the liquid filter.

31. Liquid filter of claim 22, wherein the support dome is detachably attached to the housing.

32. Liquid filter of claim 22, wherein the support dome is constructed integrally with the housing.

33. Liquid filter of claim 22, wherein the non-return valve is supported by the support dome that supports the filter surface, the support dome being affixed to the cover.

34. Liquid filter of 33, wherein the support dome is detachably attached to the cover.

35. Liquid filter of claim 33, wherein the support dome is constructed integrally with the cover.

36. Liquid filter of claim 18, wherein the dome extends beyond the filter insert and wherein the non-return valve is arranged outside of the filter insert.
